(19) United States
(12) Patent Application Publication
(10) Pub. No.: US 2001/0048561 A1
(43) Pub. Date: Dec. 6, 2001

(54) Virtual imaging system for small font text

(76) Inventor: Gregory L. Heacock, Camas, WA (US)

Correspondence Address: McANDREWS, HELD & MALLOY, LTD., 34th Floor, 500 W. Madison Street, Chicago, IL, 60661, US

(21) Appl. No.: 09/805,712

(22) Filed: Mar. 13, 2001

Related U.S. Application Data
(63) Continuation-in-part of application No. 09/645,219, filed on Aug. 24, 2000.

(51) Int. Cl. G02B 27/14

(52) U.S. Cl. 359/631; 359/630

(57) ABSTRACT

An optical system is shown for use with an image source to provide an enlarged virtual image with minimal geometric distortion. The optical system is suitable for generating a virtual image of text information in small font sizes, such as 8 point font or 10 point font, where the small font size text can be readily discerned. The optical system includes a prism having positive power wherein the total power is distributed among the prism's optical surfaces in a balanced manner and wherein the power across each surface is balanced as well. The prism employs a combination of rotationally asymmetric aspheric surfaces and a rotationally symmetric aspheric reflector so as to provide an extremely high quality virtual image across the entire width thereof, i.e. in the edge or peripheral portion of the image as well as in the central portion of the virtual image. The prism may be used alone or in combination with a thin corrector lens that not only corrects for subtle distortions but also protects the prism from contaminants.

### CROSS-REFERENCE TO RELATED APPLICATIONS

This application is a continuation-in-part of U.S. patent application Ser. No. 09/645,219 filed Aug. 24, 2000 which claims the priority of provisional application Serial No. 60/203,714 filed May 12, 2000. These applications are incorporated herein by reference.

### STATEMENT REGARDING FEDERALLY SPONSORED RESEARCH OR DEVELOPMENT

N/A

### FIELD OF INVENTION

The present invention is directed to an optical system for use with an image source to provide a virtual image and more particularly to such a system including a prism having positive, balanced power to provide an enlarged virtual image of text with minimal geometric distortion so that print in small fonts such as an 8 or 10 point font can be readily discerned.

### BACKGROUND OF THE INVENTION

Virtual imaging systems are known that include a prism with positive power to provide an enlarged virtual image. For example, U.S. Pat. No. 5,539,422 assigned to the assignee of the present invention shows a prism having three optical surfaces where each of the optical surfaces with power can be formed as a spherical surface, a cylindrical surface or a toroidal surface, i.e. a rotationally asymmetric aspheric surface. This prism has two transmissive surfaces and a reflective surface. The prism can be used in a single reflection mode of operation in which light from a display enters a first transmissive surface and is then reflected by the reflective surface to the second transmissive surface through which the light exits the prism and is directed to a user's eye. In a total internal reflection mode of operation, the prism is turned slightly with respect to the display so that light entering the first transmissive surface intersects the second transmissive surface at the angle at which total internal reflection occurs such that light is reflected from the second transmissive surface to the reflective surface. The light is then reflected by the reflective surface so that it exits the prism through the second transmissive surface. Examples of other prisms used in a total internal reflection mode of operation include U.S. Pat. Nos. 4,563,061; 4,611,877; 4,969,724; 5,249,081 and 5,459,612.

Another virtual imaging system shown in U.S. Pat. No. 5,543,816 assigned to the assignee of the present invention illustrates the use of a rotationally symmetric aspheric lens to minimize distortions across the virtual image.

Other patents that show prisms with various combinations of rotationally asymmetric aspheric surfaces with spherical and/or cylindrical and/or planar surfaces used in a single reflection mode of operation or in a total internal reflection mode of operation include U.S. Pat. Nos. 5,701,202; 5,745,295; 5,768,024; 5,790,312; 5,812,323; 5,818,641; 5,886,824; 5,909,317; 5,909,325; 5,923,477 and EP 0 687 932 A2. U.S. Pat. No. 5,701,202 is typical of these patents and shows various examples of the prism with the reflector being formed of a rotationally asymmetric aspheric surface and the two transmissive surfaces being formed of either planar, spherical or rotationally asymmetric aspheric surfaces. In another example given in U.S. Pat. No. 5,701,202, the prism is formed with a rotationally symmetric aspheric entrance surface adjacent to the display, a rotationally asymmetric aspheric reflector and a spherical total internal reflection surface that also serves as an exit surface of the prism. The virtual image generated by these systems has a central portion with high quality; whereas the edge or peripheral portion of the image is of a significantly lower quality. These systems are sufficient for producing virtual images of entertainment video such as movies since the user's focus is on the central portion of the image and not on the edges. However, due to the geometric distortion in the virtual image produced by these systems, they are not suitable for text such as typically depicted on a CRT screen or the like, in which the user's eye(s) scans across the entire width of the virtual image to read a full line of text. In order to overcome this problem, known systems have formed one or more of the optical surfaces of the prism as a complex, free formed surface such as shown, for example, in U.S. Pat. Nos. 5,917,656; 5,959,780 and 5,986,812. However, prisms with free formed surfaces are extremely difficult and costly to design and manufacture. Further, if these types of optics are decentered or used with other optics having aspheric surfaces, absolutely precise alignment is required or the image is substantially affected.

### BRIEF SUMMARY OF THE INVENTION

In accordance with the present invention, the disadvantages of prior optical systems for providing enlarged virtual images have been overcome. The system of the present invention includes a prism having positive power balanced among the prism surfaces and across each surface and employs a combination of surface shapes to provide an enlarged virtual image of text with minimal geometric distortion so that print in small font sizes such as an 8 or 10 point font can be readily discerned.

More particular, in accordance with one embodiment of the present invention, the optical system includes a prism having at least three surfaces including a transmissive entrance surface that receives light provided by an image source; a transmissive exit surface through which light passes out of the prism and a reflective surface wherein the exit surface is a rotationally asymmetric surface and the reflective surface is a rotationally symmetric surface. This prism can be used in a single reflection mode of operation or in a multiple reflection mode of operation wherein one of the transmissive surfaces reflects light by total internal reflection. Moreover, the reflective surface may be formed as a partial reflector so as to allow the prism to be used in a see-through mode of operation wherein the virtual image is superimposed upon the user's environment which can be seen through the prism.

In accordance with a preferred embodiment, both of the transmissive surfaces are formed of a rotationally asymmetric surface whereas the reflective surface is formed of a rotationally symmetric surface.

In accordance with another feature of the present invention, the optical system includes a prism having at least three physical surfaces and at least three optical surfaces with power wherein the total prism power is divided among the optical surfaces with power such that that

$$0.8 ( \frac{1}{N} ) \leq \vert \frac{{Power}_{i}}{{Power}_{T}} \vert \leq 1.2 ( \frac{1}{N} )$$

where Powerᵢ is the power of the i^{th} optical surface having power; Power_{T} is the total power of the prism and N equals the number of optical surfaces with power.

In accordance with another feature of the present invention, the optical system includes a prism having at least three optical surfaces including a rotationally asymmetric surface with a ratio of Cₓ/C_{y} that satisfies the equation

$$0.8 \leq \vert \frac{{C}_{x}}{{C}_{y}} \vert \leq 1.28$$

where

$${C}_{x} = \frac{1}{{R}_{x}}$$

and Rₓ is the radius of curvature with respect to the x axis of the prism and

$${C}_{y} = \frac{1}{{R}_{y}}$$

and R_{y} is the radius of curvature with respect to the y axis of the prism and wherein the virtual image produced by the prism has geometric distortion less than 5%.

In accordance with another feature of the present invention, the optical system includes a prism having positive optical power to enlarge an image, the prism having at least three surfaces including two transmissive surfaces and one reflective surface and the optical system also includes a corrector lens having a rotationally asymmetric aspheric surface disposed in an optical path between the prism and a user's eye wherein the optical power of the corrector lens is less than or equal to 30% of the prism's optical power.

In a preferred embodiment, the corrector lens is extremely thin, having a center thickness that is less than or equal to 3 mm. The surface of the corrector lens opposite to the aspheric surface of the lens may be planar or have positive power. However, this surface preferably has negative power and can be used in conjunction with a prism whose reflective surface is a partial reflector so as to provide a see-through virtual imaging system wherein the virtual image is superimposed upon the user's environment.

In accordance with another feature of the present invention, the optical system includes a prism and a lens disposed between the prism and the user's eye wherein both the lens and the prism are decentered relative to the central visual axis and wherein the distance between the lens and prism is fixed and the distance between the image source and the prism is variable so as to provide focus adjustment. In a preferred embodiment, it is the image source that is movable along a central axis of the source, while the decentered optical system remains stationary.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is a cross-sectional view of an image source and the optical system of the present invention with the prism operating in a total internal reflection mode;

FIG. 2 is a cross-sectional view of the optical system of FIG. 1 wherein the prism is operating in a single reflection mode; and

FIG. 3 is a cross-sectional view of another embodiment of the present invention wherein the prism has five optical surfaces.

### DETAILED DESCRIPTION OF THE INVENTION

An optical system 10 used with an image source 12 in accordance with the present invention includes a prism 14 having positive power to provide an enlarged virtual image. The prism 14 may be used alone or in combination with a thin corrector lens 16. The configurations of the prism and corrector lens are described below in detail. The image source 12 may be any type of image source including a display such as a liquid crystal display, a scanned image source, etc. Preferably, however, the image source 12 is a micro-display such as an OLED (Organic Light Emitting Device).

The surfaces of the prism 14 are formed so that the virtual image produced by the optical system 10 has minimal geometric distortion such as on the order of 5% or less. The prism surfaces are also selected to ensure that the optical system 10 delivers information with a sufficiently high MTF (Modulation Transfer Function) such that high contrast text in even small font sizes, such as 8 point font or 10 point font can be easily discerned across the entire virtual image. For example, the optical system 10 has a Modulation Transfer Function of 0.10 or higher at 20 line pairs with respect to a horizontal field of view greater than or equal to 25°. To accomplish this, the prism 14 preferably has balanced optical power with respect to each of the optical surfaces as well as with respect to the tangential and the sagittal ray propagation throughout the system as discussed in detail below. It is noted that the term optical surface as used herein refers to a surface that intersects a ray once. Therefore, a physical surface that intersects a ray, for example, twice is considered as two optical surfaces. By balancing the power among the optical surfaces of the prism, ray bending, which is a major contributor to geometric distortions and chromatic aberrations, is minimized.

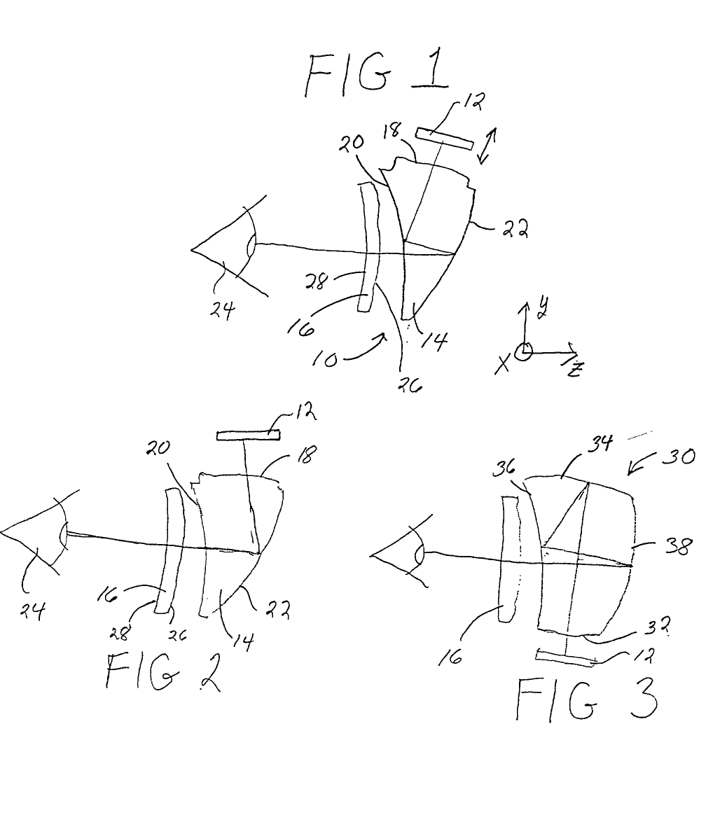

As shown in FIGS. 1 and 2, the prism 14 has two transmissive surfaces 18 and 20 and a reflective surface 22. It is noted that, the term reflective surface, as used herein refers to a surface that is fully reflective or partially reflective as obtained by reflective coatings and partially reflective coatings respectfully. The prism 14 can operate in a single reflection mode as shown in FIG. 2. In this mode, light from the display 12 enters the prism via the entrance surface 18 and is reflected by the reflective surface 22 so that the light exits through the transmissive exit surface 20 where it is thereafter directed to the user's eye 24.

In a preferred embodiment, the prism 14 is used in a total internal reflection mode of operation as shown in FIG. 1. In this embodiment, light from the display 12 enters the prism 14 through an entrance surface 18 and intersects the transmissive surface 20 at the angle at which total internal reflection occurs for the material of the prism. The material of the prism 14 can be formed of a homogeneous material having an index of refraction n that is greater than or equal to 1 or the prism may be formed of different materials so as to comprise an achromat. In a preferred embodiment, the prism 14 is a homogeneous material, such as plastic, having an index of refraction in the range of 1.48-1.70. Light that is internally reflected by the surface 20 is directed to towards the reflective surface 22 which in turn reflects the light back to the surface 20 so that the light passes therethrough, exiting the prism 14 towards the user's eye 24. In this embodiment, the entrance surface 18 is shaped as a rotationally asymmetric asphere so as to pre-distort the image in a manner that is more easily corrected than if the entrance surface of the prism was planar. The reflective surface 22 is a rotationally symmetric aspheric surface and the exit surface 20 is a rotationally asymmetric aspheric surface. Although in a preferred embodiment, each of the rotationally asymmetric aspheric surfaces 18 and 20 are anamorphic aspheric surfaces, other rotationally asymmetric aspheric surfaces may be employed as well such as a toroidal surface, a biconic surface, etc.

The equation describing the rotationally symmetric aspheric reflector 22 is as follows:

$$Z = \frac{{Cr}^{2}}{1 + \sqrt{1 - ( 1 + k ) {C}^{2} {r}^{2}}} + {A}_{1} {r}^{2} + {A}_{2} {r}^{4} + {A}_{3} {r}^{6} + …$$

The anamorphic aspheric surfaces 18 and 20 are defined by the following equation:

$$Z = \frac{{CxX}^{2} + {CyY}^{2}}{1 + \sqrt{1 - ( 1 + Kx ) ( {Cx}^{2} {X}^{2} ) - ( 1 + Ky ) ( {Cy}^{2} {Y}^{2} )}}$$

+AR[(1−AP)X²+(1+AP)Y²]²+BR[(1−BP)X²+(1+BP)Y²]³

+CR[(1−CP)X²+(1+CP)Y²]⁴+DR[(1−DP)X²+(1+DP)Y²]⁵

where

$${C}_{x} = \frac{1}{{R}_{x}}$$

and Rₓ is the radius with respect to the x axis and

$${C}_{y} = \frac{1}{{R}_{y}}$$

and R_{y} is the radius with respect to the y axis.

If a rotationally asymmetric surface in the form of a toroidal surface is employed, the curve of the surface is defined by the following equation:

$$Z = \frac{{cy}^{2}}{1 + \sqrt{1 - ( 1 + k ) {c}^{2} {y}^{2}}} {α}_{1} {y}^{2} + {α}_{2} {y}^{4} + {α}_{3} {y}^{6} + {α}_{4} {y}^{8} + {α}_{5} {y}^{10} + {α}_{6} {y}^{12} + {α}_{7} {y}^{14}$$

For a rotationally asymmetric surface that is a biconic surface, the sag of the biconic is given by the equation:

$$Z = \frac{{c}_{x} {x}^{2} + {c}_{y} {y}^{2}}{1 + \sqrt{1 - ( 1 + {k}_{x} ) {c}_{x}^{2} {x}^{2} - ( 1 + {k}_{y} ) {c}_{y}^{2} {y}^{2}}} , \\ where$$

$${c}_{x} = \frac{1}{{R}_{x}} , {c}_{y} = \frac{1}{{R}_{y}}$$

where Rₓ is the radius with respect to the x axis and R_{y} is the radius with respect to they axis.

As mentioned above, the power of the prism 14 is preferably balanced so that the total prism power is divided among the optical surfaces of the prism such that

$$0.8 ( \frac{1}{N} ) \leq \vert \frac{{Power}_{i}}{{Power}_{T}} \vert \leq 1.2 ( \frac{1}{N} )$$

where Powerᵢ is the power of the i^{th} optical surface having power; Power_{T} is the total power of the prism; and N is the number of optical surfaces with power.

Moreover, not only is the total power of the prism distributed among the optical surfaces thereof, but the optical power of each surface itself is balanced. More particularly, each of the rotationally asymmetric aspheric surfaces 18 and 20 has a ratio of Cₓ/C_{y} that satisfies

$$0.8 \leq \vert \frac{{C}_{x}}{{C}_{y}} \vert \leq 1.28$$

where

$${C}_{x} = \frac{1}{{R}_{x}}$$

and Rₓ is the radius of curvature of the rotationally asymmetric aspheric surface with respect to the x axis of the prism and

$${C}_{y} = \frac{1}{{R}_{y}}$$

and R_{y} is the radius of curvature of the rotationally asymmetric aspheric surface with respect to they axis.

In a preferred embodiment, a thin corrector lens 16 is positioned between the prism 14 and the user's eye 24. The corrector lens 16 protects the total internal reflection surface 20 from contaminants and further provides subtle distortion correction. The corrector lens 16 has a surface 26 facing the prism 14 which is a rotationally asymmetric aspheric surface such as described above. The opposite surface 28 of the corrector lens 16 may be a planar surface or a surface with positive power. However, in a preferred embodiment, the surface 28 has negative power. When the optical system is employed in a see-through mode of operation such that the reflective surface 22 is formed of a partial reflector, the corrector lens 16 is formed with a total negative power that is equal and opposite to the power of the surface 22 so that the user's view of his environment through the optical system 10 is not distorted.

The optical power of the corrector lens is less than or equal to 30% of the optical power of the prism 14. Preferably, the corrector lens has a center thickness that is less than or equal to 3 mm. Further, the corrector lens can be formed of a material having an index of refraction and dispersion qualities that are different from the index of refraction and dispersion qualities of the material forming the prism 14 so as to correct for chromatic aberrations. The corrector lens 16 may also include a liquid crystal material that modulates the brightness of the virtual image so as to accommodate variations in the ambient light so that the optical system can be used both indoors and outside.

In accordance with a preferred embodiment, both the corrector lens 16 and the prism 14 are decentered with respect to the central visual axis. In a ray tracing from the eye 24 to the display 12 the optical surfaces are preferably described as follows. The surface 28 of the corrector lens 16 is spherical having a radius of −0.0033. The surface 26 of the lens 16 is an anamorphic asphere with the following terms:

Cₓ=−0.0090819484

C_{y}=−0.0081049162

Kₓ=−47.046996

K_{y}=−8.3396299

AR=−3.5245591e−012

BR=1.0951524e−010

CR=0

DR=0

AP=−1248.1421

BP=−6.0194609

The physical surface 20 which forms two optical surfaces, the first and third optical surfaces of the prism 14 is an anamorphic asphere defined with the following terms

C=−0.0146

C_{y}=−0.014

Kₓ=15.8

K_{y}=11.7

AR=−4.89e−012

BR=1.3e−009

CR=0

DR=0

AP=−677

BP=−1.595

CP=0

DP=0

The second optical surface of the prism 14, reflective surface 22, is a rotationally symmetric aspheric surface with the following coefficients.

Coeff. on r2=0

Coeff. on r4=5.44e−006

Coeff. on r6=−7.11e−011

Coeff. on r8=5.63e−001

Coeff. on r10=0

Coeff. on r12=0

Coeff. on r14=0

Coeff. on r16=0

The next optical surface in the ray trace is again the physical surface 20 which is as described above. The fourth optical surface is the entrance surface 18 which is an anamorphic aspheric surface defined with the following terms.

Cₓ=6000

C_{y}=28000

Kₓ=−2.5

K_{y}=−4.3

AR=−2.15e−007

BR=3.27e−010

CR=0

AP=8.94

BP=2.07

CP=0

DP=0

Because both of the corrector lens 16 and the prism 14 are decentered relative to the central visual axis, it is desirable to have these elements fixed with respect to each other. In order to provide for focus adjustment, the distance between the prism 14 and the image source 12 is made variable. Although the prism and lens can be moved together with respect to the image source 12, in a preferred embodiment, it is the image source 12 that is moved relative to the prism 14 to provide for focus adjustment. In particular, the image source or display 12 is moved along the central axis of the display towards and away from the entrance surface 18 of the prism.

It is noted that the optical system 10 of the present invention can be used in a monocular head mounted display system or a pair of optical systems 10 can be provided, one system 10 for each of the user's right eye and left eye so as to provide a binocular head mounted system. When used in a binocular head mounted display system, it is noted that the corrector lens 16 can include the user's optometric prescription so that the user can use the binocular system without his, or her eyeglasses. Moreover, the optical system of the present invention may be used as a virtual imaging system incorporated into any portable device. The optical system 10 is extremely well suited for hand held devices such as cellular telephones, PDAs etc., because it is small, compact and lightweight.

It should be appreciated that many modifications can be made to the optical system 10 in accordance with the present invention. For example, the prism 14 is not limited to three physical surfaces or three optical surfaces as depicted in FIGS. 1 and 2. An example of a prism having more surfaces is depicted in FIG. 3 for a prism 30. In this embodiment, light from the display 12 enters the prism 30 through a transmissive entrance surface 32. The light from the entrance surface 32 is reflected by the opposite reflective surface 34 which reflects the light to an adjacent transmissive surface 36 at the angle that is necessary for total internal reflection. After being reflected by the transmissive surface 36, the light is reflected by a reflector 38 back to the transmissive surface 36 so that the light exits the prism 30 therethrough. After exiting the prism, the light passes through the corrector lens 16 to the user's eye. As shown in FIG. 3, the path segments of the optical path through the prism 30 extend between opposite optical surfaces except for the path segment between adjacent optical surfaces 34 and 36. Because the path of a given ray of light through the prism 30 has a greater number of segments extending between opposite optical surfaces than extending between adjacent optical surfaces, the optical element 14 has minimal complex optical distortions that must be corrected.

Many modifications and variations of the present invention are possible in light of the above teachings. Thus, it is to be understood that, within the scope of the appended claims, the invention may be practiced otherwise than as described hereinabove.

What is claimed and desired to be secured by Letters Patent is:

1. An optical system for use with an image source comprising:
a prism having positive power to enlarge an image, the prism having at least three surfaces including a transmissive surface that transmits light and also reflects light in a total internal reflection mode of operation, and a reflective surface that reflects light, one of these light reflecting surfaces being a rotationally asymmetric aspheric surface and the other of these light reflecting surfaces being a rotationally symmetric aspheric surface.

2. An optical system as recited in claim 1 wherein the transmissive surface that reflects light in a total internal reflection mode of operation is the rotationally asymmetric aspheric surface and the reflective surface is the rotationally symmetric aspheric surface.

3. An optical system as recited in claim 1 wherein the reflective surface is a partially reflecting and partially transmitting surface.

4. An optical system as recited in claim 1 wherein a third surface of the prism is a transmissive and a rotationally asymmetric aspheric surface.

5. An optical system as recited in claim 1 further including a corrector lens having a rotationally asymmetric aspheric surface, the corrector lens being positioned between the prism and a user's eye.

6. An optical system as recited in claim 1 wherein the reflective surface is a partially reflective surface having positive power and the optical system further includes a corrector lens having negative power and an aspheric surface, the corrector lens being positioned between the prism and a user's eye so as to provide a see-through system wherein the enlarged image is superimposed on the user's environment.

7. An optical system as recited in claim 1 wherein the prism has an associated total power and the total power is divided among N optical surfaces having power where N≧2 and the power of those N optical surfaces satisfies the following criteria:
$$0.8 ( \frac{1}{N} ) \leq \vert \frac{{Power}_{i}}{{Power}_{T}} \vert \leq 1.2 ( \frac{1}{N} )$$
where Powerᵢ is the power of the i^{th} optical surface having power and Power_{T} is the total power of the prism.

8. An optical system as recited in claim 1 wherein the rotationally asymmetric aspheric surface has a ratio of Cₓ/C_{y} that satisfies
$$0.8 \leq \vert \frac{{C}_{x}}{{C}_{y}} \vert \leq 1.28$$
where
$${C}_{x} = \frac{1}{{R}_{x}}$$
and Rₓ is the radius of curvature of the rotationally asymmetric aspheric surface with respect to the x axis of the prism and
$${C}_{y} = \frac{1}{{R}_{y}}$$
and R_{y} is the radius of curvature of the rotationally asymmetric surface with respect to the y axis.

9. An optical system as recited in claim 8 wherein the horizontal field of view of the prism is between 25° and 45° and a virtual image produced by the prism has geometric distortion less than or equal to 5°.

10. An optical system for use with an image source comprising:
a prism having positive power to enlarge an image, the prism having at least three surfaces including at least two transmissive, rotationally asymmetric aspheric surfaces and a reflective, rotationally symmetric aspheric surface.

11. An optical system as recited in claim 10 wherein the reflective surface is a partially reflecting and partially transmitting surface.

12. An optical system as recited in claim 10 wherein at least one of said transmissive surfaces is an anamorphic aspheric surface.

13. An optical system as recited in claim 10 wherein at least one of said transmissive surfaces is a biconic surface.

14. An optical system as recited in claim 10 wherein at least one of said transmissive surfaces is a toroidal surface.

15. An optical system as recited in claim 10 further including a corrector lens having a rotationally asymmetric aspheric surface, the corrector lens being positioned between the prism and a user's eye.

16. An optical system as recited in claim 10 wherein the reflective surface is a partially reflective surface having positive power and the optical system further includes a corrector lens having negative power and an aspheric surface, the corrector lens being positioned between the prism and a user's eye so as to provide a see-through system wherein the enlarged image is superimposed on the user's environment.

17. An optical system as recited in claim 10 wherein the prism has an associated total power and the total power of the prism is divided among N optical surfaces having power where N≧2 and the power of those N optical surfaces satisfies the following criteria:
$$0.8 ( \frac{1}{N} ) \leq \vert \frac{{Power}_{i}}{{Power}_{T}} \vert \leq 1.2 ( \frac{1}{N} )$$
where Powerᵢ is the power of the i^{th} optical surface having power and Power_{T} is the total power of the prism.

18. An optical system as recited in claim 10 wherein the rotationally asymmetric aspheric surface has a ratio of Cₓ/C_{y} that satisfies
$$0.8 \leq \vert \frac{{C}_{x}}{{C}_{y}} \vert \leq 1.28$$
where
$${C}_{x} = \frac{1}{{R}_{x}}$$
and Rₓ is the radius of curvature of the rotationally asymmetric aspheric surface with respect to the x axis of the prism and
$${C}_{y} = \frac{1}{{R}_{y}}$$
and R_{y} is the radius of curvature of the rotationally asymmetric surface with respect to the y axis.

19. An optical system as recited in claim 18 wherein the horizontal field of view of the prism is between 25° and 45° and the virtual image produced by the prism has geometric distortion less than or equal to 5%.

20. An optical system comprising:
an image source providing light forming an image;
a prism having positive power to enlarge the image, the prism having at least three surfaces including a transmissive entrance surface that receives light provided by the image source, a transmissive exit surface through which light passes out of the prism and a reflective surface, wherein said exit surface is a rotationally asymmetric surface and said reflective surface is a rotationally symmetric surface.

21. An optical system as recited in claim 20 wherein said exit surface is an anamorphic aspheric surface.

22. An optical system as recited in claim 20 wherein said exit surface is a biconic surface.

23. An optical system as recited in claim 20 wherein said exit surface is a toroidal surface.

24. An optical system as recited in claim 20 wherein said entrance surface is a rotationally asymmetric aspheric surface.

25. An optical system as recited in claim 24 wherein said entrance surface is an anamorphic aspheric surface.

26. An optical system as recited in claim 24 wherein said entrance surface is a biconic surface.

27. An optical system as recited in claim 24 wherein said entrance surface is a toroidal surface.

28. An optical system as recited in claim 20 further including a corrector lens having a rotationally asymmetric aspheric surface, the corrector lens being positioned between the prism and a user's eye.

29. An optical system as recited in claim 20 further including a corrector lens disposed in an optical path between the prism and a user's eye wherein the corrector lens and the prism are decentered with respect to a central visual axis and the distance between the corrector lens and the prism is fixed and the distance between the prism and the image source is variable.

30. An optical system as recited in claim 20 further including a corrector lens disposed in an optical path between the prism and a user's eye wherein the corrector lens and the prism are decentered with respect to a central visual axis and the distance between the corrector lens and the prism is fixed and the image source is movable with respect to the prism.

31. An optical system as recited in claim 20 wherein the reflective surface is a partially reflective surface having positive power and the optical system further includes a corrector lens having negative power and an aspheric surface, the corrector lens being positioned between the prism and a user's eye so as to provide a see-through system wherein the enlarged image is superimposed on the user's environment.

32. An optical system as recited in claim 20 wherein the reflective surface is a partially reflecting and partially transmitting surface.

33. An optical system as recited in claim 20 wherein the prism has an associated total power and the total power of the prism is divided among N optical surfaces having power where N≧2 and the power of those N optical surfaces satisfies the following criteria:
$$0.8 ( \frac{1}{N} ) \leq \vert \frac{{Power}_{i}}{{Power}_{T}} \vert \leq 1.2 ( \frac{1}{N} )$$
where Powerᵢ is the power of the i^{th} optical surface having power and Power_{T} is the total power of the prism.

34. An optical system as recited in claim 20 wherein the rotationally asymmetric aspheric surface has a ratio of Cₓ/C_{y} that satisfies
$$0.8 \leq \vert \frac{{C}_{x}}{{C}_{y}} \vert \leq 1.28$$
where
$${C}_{x} = \frac{1}{{R}_{x}}$$
and Rₓ is the radius of curvature of the rotationally asymmetric aspheric surface with respect to the x axis of the prism and
$${C}_{y} = \frac{1}{{R}_{y}}$$
and R_{y} is the radius of curvature of the rotationally asymmetric surface with respect to they axis.

35. An optical system as recited in claim 34 wherein the horizontal field of view of the prism is between 25° and 45° and the virtual image produced by the prism has geometric distortion less than or equal to 5%.

36. An optical system for use with an image source comprising:
a prism having positive optical power to enlarge an image, the prism having at least three surfaces including two transmissive surfaces and one reflecting surface, the prism being decentered with respect to a central visual axis; and
a corrector lens having an associated optical power and an aspheric surface disposed in an optical path between the prism and a user's eye, the optical power of the corrector lens being less than or equal to 30% of the prism's optical power and the center thickness of the corrector being less than or equal to 3 mm.

37. An optical system as recited in claim 36 wherein the corrector lens has a planar surface opposite the aspheric surface.

38. An optical system as recited in claim 36 wherein the reflecting surface of said prism is a partially reflective surface having positive power and the corrector lens has negative power equal in magnitude to the power of the reflecting surface.

39. An optical system as recited in claim 36 wherein the corrector lens has a surface, opposite to the aspheric surface, that is concave with respect to a user's eye.

40. An optical system as recited in claim 36 wherein the aspheric surface of the corrector lens is a rotationally asymmetric asphere.

41. An optical system as recited in claim 36 wherein the corrector lens is formed of a material having an index of refraction and dispersion qualities that are different from the index of refraction and dispersion qualities of the material forming the prism.

42. An optical system as recited in claim 36 wherein the lens includes a liquid crystal material that modulates the brightness of the enlarged image.

43. An optical system as recited in claim 36 wherein the lens includes a user's optometric prescription and the system is mounted on a support to be worn on a user's head.

44. An optical system as recited in claim 36 wherein the distance between the corrector lens and prism is fixed and the image source is a display movable with respect to the prism.

45. An optical system for use with an image source comprising:
a prism having positive power to enlarge an image, the prism having at least three surfaces including two transmissive surfaces and one reflective surface wherein at least one of the transmissive surfaces functions in a total internal reflection mode; and
a corrector lens having an aspheric surface disposed in an optical path between the prism and a user's eye, the corrector lens having a center thickness that is less than or equal to 3 mm.

46. An optical system as recited in claim 45 wherein the corrector lens has a planar surface opposite the aspheric surface.

47. An optical system as recited in claim 45 wherein the reflecting surface of said prism is a partially reflective surface having positive power and the corrector lens has negative power equal in magnitude to the power of the reflecting surface.

48. An optical system as recited in claim 45 wherein the corrector lens has a surface, opposite to the aspheric surface, that is concave with respect to a user's eye.

49. An optical system as recited in claim 45 wherein the corrector lens is formed of a material having an index of refraction and dispersion qualities that are different from the index of refraction and dispersion qualities of the material forming the prism.

50. An optical system as recited in claim 45 wherein the lens includes a liquid crystal material that modulates the brightness of the enlarged image.

51. An optical system as recited in claim 45 wherein the lens includes a user's optometric prescription and the system is mounted on a support to be worn on a user's head.

52. An optical system as recited in claim 45 wherein the distance between the corrector lens and prism is fixed and the image source is a display movable with respect to the prism.

53. An optical system for use with an image source comprising:
a prism having a positive total power to enlarge an image and at least three physical surfaces and at least three optical surfaces with power wherein the total prism power is divided among the optical surfaces with power such that
$$0.8 ( \frac{1}{N} ) \leq \vert \frac{{Power}_{i}}{{Power}_{T}} \vert \leq 1.2 ( \frac{1}{N} )$$
where Powerᵢ is the power of the i^{th} optical surface having power; Power_{T} is the total power of the prism and N is the number of optical surfaces with power.

54. An optical system as recited in claim 53 wherein said prism includes at least one rotationally asymmetric aspheric surface.

55. An optical system as recited in claim 53 wherein said prism includes at least one rotationally symmetric aspheric surface.

56. An optical system as recited in claim 53 wherein said prism has a horizontal field of view that is between 25° and 45° and the virtual image produced by the prism has geometric distortion of 5° or less.

57. An optical system as recited in claim 53 further including a corrector lens having a rotationally asymmetric aspheric surface, the corrector lens being positioned between the prism and a user's eye.

58. An optical system for use with an image source comprising:
a prism having a positive total power to enlarge an image and at least three physical surfaces and at least three optical surfaces with power wherein the total prism power is divided among the optical surfaces with power such that
$$0.8 ( \frac{1}{N} ) \leq \vert \frac{{Power}_{i}}{{Power}_{T}} \vert \leq 1.2 ( \frac{1}{N} )$$
where Powerᵢ is the power of the i^{th} optical surface having power; Powerᵢ is the total power of the prism; and N is the number of optical 10 surfaces with power and at least one of the optical surfaces with power is a rotationally asymmetric aspheric surface having a ratio of Cₓ/C_{y} that satisfies the equation:
$$0.8 \leq \vert \frac{{C}_{x}}{{C}_{y}} \vert \leq 1.28$$
where
$${C}_{x} = \frac{1}{{R}_{x}}$$
and Rₓ is the radius of curvature with respect to the x axis of the prism and
$${C}_{y} = \frac{1}{{R}_{y}}$$
and R_{y} is the radius of curvature with respect to they axis of the prism.

59. An optical system as recited in claim 58 wherein the virtual image produced by the prism has geometric distortion less than 5%.

60. An optical system as recited in claim 58 wherein the field of view is between 25° and 45°.

61. An optical system as recited in claim 58 wherein the prism has at least one aspheric surface that is a rotationally symmetric aspheric surface.

62. An optical system for use with an image source comprising:
a prism having an index of refraction n such that 1<n<2 and having positive power for generating an enlarged virtual image, the prism having at least three optical surfaces including a rotationally asymmetric surface with a ratio of Cₓ/C_{y} that satisfies the equation
$$0.8 \leq \vert \frac{{C}_{x}}{{C}_{y}} \vert \leq 1.28$$
where
$${C}_{x} = \frac{1}{{R}_{x}}$$
and Rₓ is the radius of curvature with respect to the x axis of the prism and
$${C}_{y} = \frac{1}{{R}_{y}}$$
and R_{y} is the radius of curvature with respect to the y axis of the prism wherein a virtual image produced by the prism has geometric distortion less than 5%.

63. An optical system comprising:
a display providing light forming an image, the display having a central visual axis;
a prism having positive power to enlarge the image, the prism having at least three surfaces including two transmissive surfaces and a reflective surface, wherein at least one of the surfaces is an aspheric surface and the prism is decentered with respect to a central visual axis;
a corrector lens positioned between the prism and a user's eye, the corrector lens having an aspheric surface and being decentered with respect to the central visual axis, wherein the distance between the corrector lens and the prism is fixed and the distance between the prism and display is variable.

64. An optical system comprising:
a display providing light forming an image, the display having a central axis;
a prism having positive power to enlarge the image, the prism having at least three surfaces including two transmissive surfaces and a reflective surface and the prism being decentered with respect to a central visual axis; and
a corrector lens positioned between the prism and a user's eye, the corrector lens having at least one surface shaped to correct for distortions in a virtual image produced by the optical system, said corrector lens being decentered with respect to a central visual axis and the distance between the corrector lens and the prism being fixed and the display being movable with respect to the prism along the central axis of the display.
